(19) United States
(12) Patent Application Publication
(10) Pub. No.: US 2003/0090428 A1
(43) Pub. Date: May 15, 2003

(54) Method for decoupling antennae within a system of co-localized antennae, and corresponding sensor and application

(76) Inventors: Francois Marie, Rennes (FR); Louis Bertel, Thorigne-Fouillard (FR); Dominique Lemur, Rennes (FR)

Correspondence Address: Westman Champlin & Kelly, International Centre Suite 1600, 900 Second Avenue South, Minneapolis, MN, 55402-3319, US

(21) Appl. No.: 10/168,767

(22) PCT Filed: Dec. 14, 2000
(86) PCT No.: PCT/FR00/03544

(51) Int. Cl. H01Q 1/00; H01Q 7/08

(52) U.S. Cl. 343/787; 343/788

(57) ABSTRACT

The invention relates to a sensor of the type that comprises a system of co-localized antennae, itself comprising at least two active antennae (1) with the same phase center, said antennae being placed at the top end of a mast (4) and connected to down conductors (3). According to the invention, said mast (4) is produced from a dielectric material in such a way as to enable the antennae to be decoupled. The sensor also has filtering means (5₁ to 5ₙ) which are arranged on at least one of said down conductors.

The domain of this invention is colocated antenna systems, in other words electronic systems comprising several active antennas grouped at a single point in order to achieve the same phase centre.

More precisely, the invention relates to a sensor of the type comprising this type of colocated antenna system and a mast on top of which the antennas are located, and down cables to one or more receivers to which the antennas are connected. The invention has many applications, such as:

radio direction finding with a single station. Replacing the space dimension in angle of arrival search algorithms (azimuth and elevation) by knowledge of antenna responses is a means of determining the values of the required angles;

rejection of interference;

transmission, for example using reception on several antennas (multichannel reception);

pseudo-space filtering (substitution of the space dimension by the antenna diversity dimension);

beamforming;

etc.

The following articles provide further information about some of these applications:

Communications:

L Bertel, 0. Lebaillif, Y. Leroux, R. Fleury, “Influence of antennas and propagation on the behaviour of an H.F digital transmission system”, AGARD, Athens, Greece—September 1995;

Measurements of angles of arrival:

F. Marie, “Design, production and test of a sensor composed of HF colocated antennas” PhD thesis at the University of Rennes, 1999;

Y. Erhel, A. Edjeou, L. Bertel, “Contribution of the polarization diversity in H.F. direction finding systems”, in Proceedings of the SPIE's 1994 International Symposium, Jul. 24-29, 1994, San Diego USA;

F. Marie, L. Bertel, D. Lemur, Y. Erhel, “Comparison of HF direction finding experimental results obtained with circular and colocated antenna arrays”, Ionospheric Effects Symposium 99, Alexandria, May 3-6, 1999;

Y. Erhel and L. Bertel, F. Marie “A method of direction finding operating on an array of colocated antennas” 1998 IEEE/APS/URSI International Symposium, Atlanta, Jun. 21-26, 1998;

Filtering:

C. Le Meins, Y. Erhel, L. Bertel, F. Marie “Source separation operating on a set of colocated antennas: theory and application in the HF band (3-30 MHz)”, 1999 Antenna Applications Symposium (IEEE), Sep. 15 17, 1999, Monticello, USA.

More generally, it is used in applications in which it is required to know and use responses of different colocated antennas.

An antenna response within the context of this description applies to a relation (generally vectorial) between the incident electrical (or magnetic) field at an antenna and the signal present at the output from this antenna. Polarization relations deduced from Maxwell equations can be used to show that this response can be represented by a complex quantity that depends on the type of the antenna, its environment, its geographic position (in high frequency) typically 3-30 MHz, and its orientation. In general, antenna responses may be obtained either by calculation or simulation, or by different measurements carried out on the colocated antenna system.

It is only possible to use antenna responses if these antennas are well decoupled from each other electromagnetically. This is not the case for sensors proposed by manufacturers at the present time. The inventors of this invention have determined that with known sensors, there is an electromagnetic coupling between antennas induced by the existence of:

a first type of coupling between current distributions present on radiating parts of antennas and current distributions that exist on the conducting mast;

a second type of coupling between current distributions present on radiating parts of antennas and current distributions on down cables.

The different current distributions mentioned above are surface current distributions.

The purpose of this invention is particularly to overcome this major disadvantage in the state of the art.

More precisely, one of the purposes of this invention is to provide a sensor of the type mentioned above (particularly including a colocated antenna system, a mast and a down cable) but in which the antennas are electromagnetically decoupled from each other.

Another purpose of the invention is to enable this type of decoupling simply and at low cost.

Another purpose of the invention is to enable this type of decoupling within wide frequency ranges.

These various purposes and others that will appear later are achieved according to the invention using a sensor of the type including a system of colocated antennas, this system comprising at least two active antennas with the same phase centre, the said antennas being placed at the top of a mast and connected to down cables.

According to this invention, the mast is made from a dielectric material and the sensor comprises filter means located on at least one of the said down cables to enable decoupling of the said antennas.

Therefore the general principle of the invention consists of eliminating the first and second types of coupling mentioned above, using a dielectric mast (elimination of current distributions on the mast) for the first type, and filter means on the down cables (attenuation or even elimination of current distributions on these cables) for the second type.

Advantageously, the said filter means comprise ferrite elements (preferably ferrite toruses or tubes) around which at least one of the said down cables is wound.

The characteristics of the ferrite elements are chosen so as to introduce the required attenuation (typically 30 dB) of surface currents at the frequencies considered. The toruses have good efficiency due to the fact that there is a closed loop. Furthermore, the tubes facilitate assembly since the cables may easily be slid into them.

Advantageously, there are at least two different types of the said ferrite elements. Thus, filtering is done within a wide frequency band. The order in which the ferrite type is placed on the cables is unimportant.

Preferably, the said filter means comprise at least two filters distributed on at least one of the said down cables, and each of the said filters comprises at least one ferrite element. This type of regular or irregular spacing of filters is designed to optimise the filter quality for a given cable length and for a given frequency band.

Advantageously, at least one first filter among the said at least two filters is placed immediately at the exit from the active parts of the said antennas. The active parts of the antennas are sometimes called electronic parts.

Preferably, at least one last filter among the said at least two filters is placed at the ground level. If there are any surface currents (on the casing) they tend to reach the lowest possible potential (the power supply zero or earth). The invention prevents an induced current on an antenna from inducing a surface current that could reach a power supply zero for another antenna or escape to the earth. Once the lines have reached the ground, the surface currents are only generated weakly and tend to be naturally attracted by the ground. However, for safety reasons, some decoupling (filter) devices are kept at ground level, for example over a few centimetres.

Advantageously, each of the said antennas comprises an active part and a radiating part, and the active parts of the said antennas are contained in metal boxes that are electrically isolated from each other. This further reduces electromagnetic coupling effects. This avoids an antenna current from escaping from one box to another.

Advantageously, the said metal boxes are located immediately at the exit from the radiating parts of the said antennas. This prevents the presence of a cable segment forming an unwanted radiating part. In other words, adaptation between the impedance of the radiating part and the input impedance of the metal boxes is optimised.

According to one advantageous variant, the said filter means comprise at least one optical cable forming at least one of the said down cables. The lack of any surface current on the optical cables avoids the second type of coupling mentioned above (between current distributions present on the radiating parts of the antennas and current distributions existing on conventional metallic type cables).

Preferably, the length of the down cable on which the said filter means are located is limited to the height at which the said antennas are placed at the top end of the mast.

There is no point in putting filters over the entire length of the portion of each cable that is supported on the ground if the length of this cable on which the filter is placed is equal to at least the height on which the corresponding antenna is placed.

Advantageously, at least one of the said down cables is placed inside the said mast. This thus improves the global aesthetics of the sensor. Note that this characteristic that is possible because the mast is made of a dielectric material is not compulsory for correct operation.

Advantageously, at least one of the said antennas is an active whip antenna replacing a vertical dipole type antenna. The objective is to prevent a radiating element of an antenna (such as a line of a vertical dipole) from being in the immediate vicinity of the down cables.

Advantageously, the said antennas are of different types and/or polarizations, in order to create a said antenna diversity.

Note that the use of different types of antennas is useful because decorrelation of the received signals depends on antenna responses. If the same types of antennas are used with a different layout, the responses may be mathematically too close.

Advantageously, the said down cables are provided for power supplies for the said antennas and/or the transport of signals output from the said antennas. Note that the antennas must be powered since they are active. Furthermore, the signals are transported from the antennas to the receiver(s). In many applications, a single cable (power supply/transport of signals), for example a coaxial type cable, may be used to connect each antenna to the receiver.

The invention also relates to an antenna decoupling process within a system of colocated antennas of the type comprising at least two active antennas with the same phase centre, the said antennas being placed at the top end of a mast and being connected to down cables. According to the invention, this process consists of making the mast from a dielectric material, and placing filter means on at least one of the said down cables.

Other characteristics and advantages of the invention will become clear from reading the following description of a preferred embodiment of the invention, given as an example but in no way limitative, and the attached drawings in which:

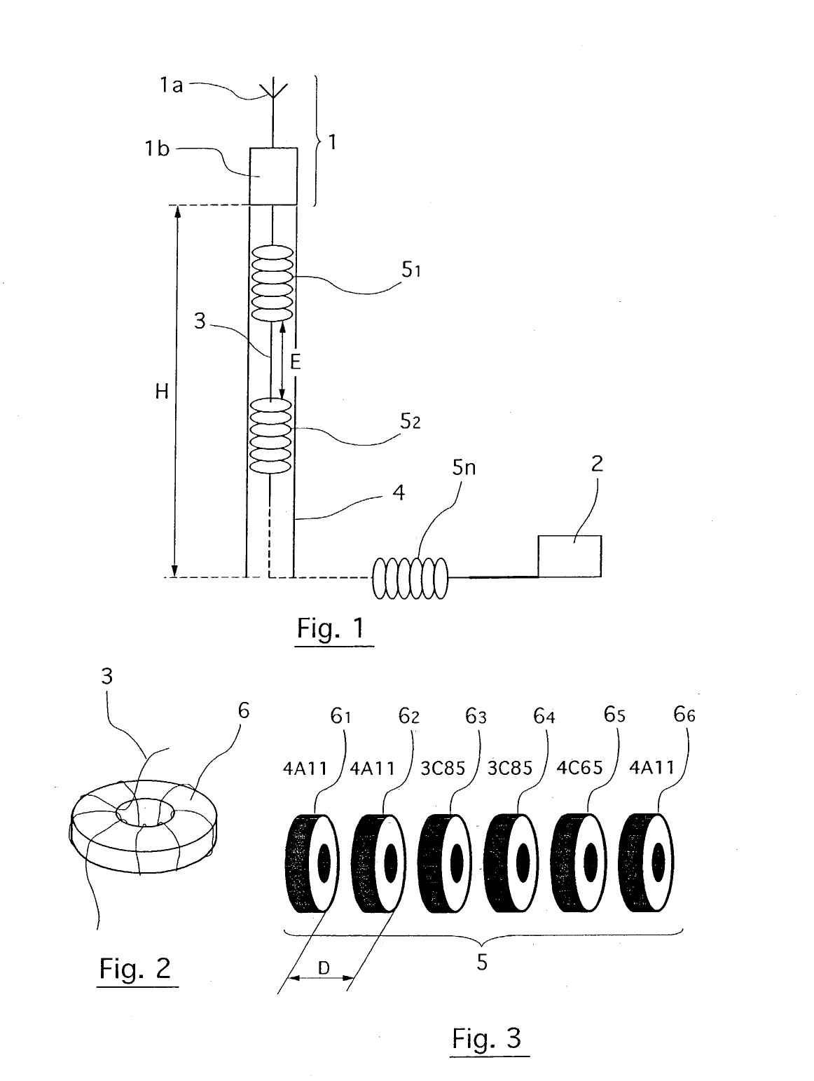

FIG. 1 shows a simplified partial diagram of a particular embodiment of a sensor according to the invention,

FIGS. 2 and 3 show details of a particular embodiment of the filters in FIG. 1,

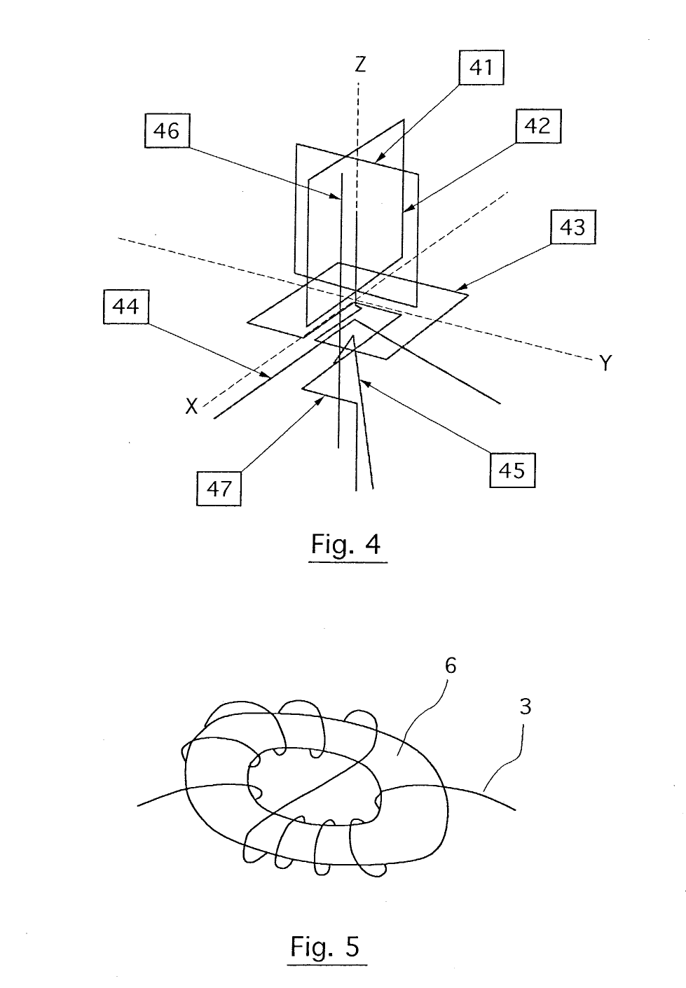

FIG. 4 shows a perspective view of a particular embodiment of the radiating parts of the colocated antenna system shown in FIG. 1, and

FIG. 5 shows a particular embodiment of a cable wound around a ferrite element.

Therefore, the invention relates to a sensor of a type comprising a system of colocated antennas (see FIG. 4), a mast (at the top of which the antennas are placed) and down cables (from antennas to one or several receivers).

For simplification purposes, FIG. 1 illustrates only the link through a single down cable 3 between one 1 of the said antennas in the colocated antenna system and a receiver 2. Obviously in reality, each antenna in the colocated antenna system is connected through a down cable to a receiver. Not all antennas are necessarily connected to the same receiver. Several antennas can use a single down cable (multiplexing technique).

Antenna 1 is located at the top end of mast 4 at a height H from the ground. It comprises an active part 1a and a radiating part 1b. The active part 1a, also called the antenna preamplifier, is contained in a metal box. It is defined as a function of the antenna radiation impedance, to give the best possible match between the radiating part 1b and the down cable 3 (for example 50Ω). The metal boxes of active parts of the different colocated antennas are electrically insulated from each other and are located immediately at the ends of the radiating parts.

The single down cable 3 supplies power and transports signals output from antenna 1.

The mast 4 is made from a dielectric material. In the example shown in FIG. 1, it is hollow and the down cables 3 are located on the inside.

Each down cable 3 is associated with several filters 5₁, 5₂, . . . , 5ₙ in order to decouple the antennas. The first filter 5₁ is located immediately behind the active part 1b of the antenna 1, starting from which the down cable 3 extends. The last filter(s) 5ₙ is (are) placed at ground level. However, there is no point in placing filters over the entire length of the cable portion that remains on the ground, provided that the length of the portion of the cable on which the filters are placed exceeds the height at which the antenna is placed.

We will now describe a particular embodiment of these filters 5₁, 5₂, . . . , 5ₙ with relation to FIGS. 2 and 3, for example using ferrites obtained from Philips Components, with the following references:

TN36/23/15 4C65 violet;

TN36/23/15 4A11 pink;

TN36/23/15 3C85 red.

In the example shown in FIG. 3, each filter 5 comprises six ferrite toruses 6₁ to 6₆, namely a type 4C65 torus 6₅, three type 4A11 toruses 6₁, 6₂ and 6₆ and two 3C85 types 6₃ and 6₄. There is a space D of about 4 cm between two successive toruses. For example, filters are put along cable 3 at a spacing E of about 30 to 50 cm. The attenuations obtained with these filters vary from 45 dB at a frequency of 6 MHz to 40 dB at a frequency of 30 MHz.

As shown in FIG. 2, the down cable 3 is wound several times (for example between eight and nine turns) around each ferrite tore 6. For example, it may be a type RG58 coaxial cable. It is clear that the portion of cable connected to the receiver 2 may be made using a different type of cable, for example such as a POPE H1000 type low loss coaxial cable (loss 1 dB at 100 m, from 3 MHz to 30 MHz) and with a high shield (external jacket composed of copper foil).

As shown in FIG. 5, the decoupling effect can be improved by making n turns in one direction and then n turns in the other direction, passing through the ferrite along a diagonal (when changing direction). n is preferably equal to m.

We will now describe a partial view of an example of a system with seven colocated antennas, with relation to FIG. 4, comprising the following seven radiating parts:

three frames place orthogonally, two of them 41, 42 being perpendicular to each other in a vertical plane, and a third 43 being placed horizontally,

two horizontal dipoles 44, 45 perpendicular to each other,

a vertical dipole 46 (possibly replaced by an active whip type antenna) (not shown) to prevent a line of the vertical dipole being in the immediate vicinity of the down cables,

an antenna 47 called XYZ.

The sensor described above may be used in particular, but not exclusively at HF (3 to 30 MHz), VHF (30 to 300 MHz) and UHF (300 MHz to 3 GHz). The filters must be made with ferrites adapted to working frequencies.

It may be used in many applications, particularly such as radio direction finding, rejection of interference, transmissions, pseudo-space filtering, beamforming, etc.

1. Sensor of the type comprising a system of colocated antennas, itself comprising two active antennas (1; 41 to 47) with the same phase centre, the said antennas being placed at the top of a mast (4) and being connected to down cables (3),
characterized in that the said mast (4) is made from a dielectric material, and that the said sensor comprises filter means (5; 5₁ to 5ₙ) located on at least one of the said down cables,
in order to achieve decoupling of the said antennas.

2. Sensor according to claim 1, characterized in that the said filter means comprise ferrite elements (6₁ to 6₆) around which at least one of the said down cables (3) is wound.

3. Sensor according to claim 2, characterized in that the said at least one down cable is wound around each ferrite element with n turns in a first direction and n turns in a second opposite direction, where n and m ≧1.

4. Sensor according to either of claims 2 and 3, characterized in that the said ferrite elements are included in a group comprising:
ferrite toruses (6₁ to 6₆)
ferrite tubes.

5. Sensor according to any one of claims 2 to 4, characterized in that there are at least two types of the said ferrite elements.

6. Sensor according to any one of claims 2 to 5, characterized in that the said filter means comprise at least two filters (5; 5₁ to 5ₙ) distributed on at least one of the said down cables,
and in that each of the said filters comprises at least one ferrite element (6₁ to 6₆).

7. Sensor according to claim 6, characterized in that each of the said antennas comprises an active part (1b) and a radiating part (1a),
and in that at least one filter (5₁) among the said at least two filters is located immediately at the output from the active parts of the said antennas.

8. Sensor according to either of claims 6 or 7, characterized in that at least a last filter (5ₙ) among the said at least two filters is at ground level.

9. Sensor according to any one of claims 1 to 8, characterized in that each of the said antennas comprises an active part (1b) and a radiating part (1a) and in that the said active parts of the said antennas are contained in metal boxes that are electrically isolated from each other.

10. Sensor according to claim 9, characterized in that the said metal boxes are located immediately at the exit from the radiating parts of the said antennas.

11. Sensor according to any one of claims 1 to 10, characterized in that the said filter means comprise at least one optical cable forming at least one of the said down cables.

12. Sensor according to any one of claims 1 to 11, characterized in that the length of the down cable on which the said filter means are placed is limited to the height (H) at which the said antennas are installed, at the top of the mast.

13. Sensor according to any one of claims 1 to 12, characterized in that at least one of the said down cables (3) is located inside the said mast (4).

14. Sensor according to any one of claims 1 to 13, characterized in that at least one of the said antennas is an active whip type antenna replacing a vertical dipole type antenna.

15. Sensor according to any one of claims 1 to 14, characterized in that the said antennas are of different types and/or polarizations, to create a said antenna diversity.

16. Sensor according to any one of claims 1 to 15, characterized in that the said down cables (3) are related to power supplies of the said antennas and/or transport of signals output from the said antennas.

17. Antenna decoupling process within a system of colocated antennas, of the type comprising at least two active antennas (1; 41 to 47) with the same phase centre, the said antennas being located at the top of a mast (4) and being connected to down cables (3),
characterized in that the said mast (4) is made of a dielectric material,
and in that filter means (5; 5₁ to 5ₙ) are placed on at least one of the said down cables.

18. Sensor application according to any one of claims 1 to 16, for a technique belonging to the group consisting of:
radio direction finding;
rejection of interference;
transmissions;
pseudo-space filtering;
beamforming.
